(19) United States
(12) Patent Application Publication
(10) Pub. No.: US 2018/0181719 A1
(43) Pub. Date: Jun. 28, 2018

(54) VIRTUAL HEALTHCARE PERSONAL ASSISTANT

(71) Applicant: CERNER INNOVATION, INC., Kansas City, KS (US)

(72) Inventor: RICHARD MATTHEW BALIAN, DOWNINGTOWN, PA (US)

(21) Appl. No.: 15/392,600

(22) Filed: Dec. 28, 2016

(51) Int. Cl. G06F 19/00; G06Q 50/00

(52) U.S. Cl. CPC G06F 19/345; G06Q 50/01; G06F 19/3418; G06F 19/328; G06F 19/327; G06F 19/3481; G06F 19/322

(57) ABSTRACT

A virtual healthcare personal assistant is provided to assists a patient in healthcare decision making. Healthcare data is received for the patient from multiple interfaces including an electronic health record, insurance systems, pharmacy systems, remote monitoring systems, clinician scheduling systems, patient social media systems, and a patient mobile device. The healthcare data is then provided to a machine learning device that is trained to analyze the healthcare data. Based on the analysis of the healthcare data, medical and preventive healthcare personal assistant services for the patient via the patient mobile device.

### BACKGROUND

With medical care expenses compounding every year, effective personal healthcare decision making is essential. Patients are often faced with decisions on when to self-treat or when to seek medical attention. Even when seeking medical attention, patients are faced with choosing the appropriate venue for treatment or a general practitioner versus a specialist. For example, a patient may visit an emergency room rather than a general practitioner. Or the patient may visit a specialist when a visit to the general practitioner may be more appropriate and cost-effective (or vice versa). Patients may also benefit from preventive care decisions that could be made based on personal lifestyle, family history, age, gender, and the like and not doing so could result in additional risk and costs. Overall errors in personal healthcare situations contribute to decreased quality of care, decreased quality of life, and increased cost of healthcare.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present disclosure relate to systems, methods, and user interfaces for providing a virtual healthcare personal assistant. In particular, the virtual healthcare personal assistant assists a patient in healthcare decision making. To do so, healthcare data is received for the patient from multiple interfaces. For example, the healthcare data may be received from an electronic health record, insurance systems, pharmacy systems, remote monitoring systems, clinician scheduling systems, patient social media systems, and a patient mobile device. The healthcare data is then provided to a machine learning device that is trained to analyze the healthcare data. Based on the analysis of the healthcare data, medical and preventive healthcare personal assistant services for the patient via the patient mobile device.

In embodiments, the medical and preventive healthcare personal assistant services comprise one or more of: recommending physical actions to be taken by the user in accordance with a specific condition, medical history, and other information derived from the healthcare data, automatically seeking or scheduling appointments with clinicians or laboratory or testing facilities, or communicating prescriptions or refill requests to pharmacies and/or orders for over-the counter medications to vendors. Additionally, guidance may be provided to patient contacts that include instructions for monitoring, transport, or support of the patient before or after a particular action is taken.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee. The present invention is described in detail below with reference to the attached drawing figures, wherein:

FIG. 1 is a block diagram of an exemplary computing environment suitable for use in implementing the present invention;

FIG. 2 is a block diagram of an exemplary system for providing a virtual healthcare personal assistant, in accordance with an embodiment of the present invention;

FIG. 3 is a flow diagram showing an exemplary method of providing a virtual healthcare personal assistant, in accordance with various embodiments of the present invention; and

FIG. 4 is a flow diagram showing an exemplary method of providing a virtual healthcare personal assistant, in accordance with various embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

As noted in the Background, with medical care expenses compounding every year, effective personal healthcare decision making is essential. Patients are often faced with decisions on when to self-treat or when to seek medical attention. Even when seeking medical attention, patients are faced with choosing the appropriate venue for treatment or a general practitioner versus a specialist. For example, a patient may visit an emergency room rather than a general practitioner. Or the patient may visit a specialist when a visit to the general practitioner may be more appropriate and cost-effective (or vice versa). Patients may also benefit from preventive care decisions that could be made based on personal lifestyle, family history, age, gender, and the like and not doing so could result in additional risk and costs. Overall errors in personal healthcare situations contribute to decreased quality of care, decreased quality of life, and increased cost of healthcare.

Embodiments of the present disclosure relate to systems, methods, and user interfaces for providing a virtual healthcare personal assistant. In particular, the virtual healthcare personal assistant assists a patient in healthcare decision making. To do so, healthcare data is received for the patient from multiple interfaces. For example, the healthcare data may be received from an electronic health record, insurance systems, pharmacy systems, remote monitoring systems, clinician scheduling systems, patient social media systems, and a patient mobile device. The healthcare data is then provided to a machine learning device that is trained to analyze the healthcare data. Based on the analysis of the healthcare data, medical and preventive healthcare personal assistant services for the patient via the patient mobile device.

In embodiments, the medical and preventive healthcare personal assistant services comprise one or more of: recommending physical actions to be taken by the user in accordance with a specific condition, medical history, and other information derived from the healthcare data, automatically seeking or scheduling appointments with clinicians or laboratory or testing facilities, or communicating prescriptions or refill requests to pharmacies and/or orders for over-the counter medications to vendors. Additionally, guidance may be provided to patient contacts that include instructions for monitoring, transport, or support of the patient before or after a particular action is taken.

In this way, the exponential rate of increase in healthcare spending can be slowed and treatment options can be provided to those without insurance. Additionally, health and wellness can be promoted at an individualized level, a wide range of treatment options (e.g., self-treatment), an increased efficiency of specialist referrals, and preventive care can be provided, appropriate venues can be selected, scheduling is automated and more easily accessible, and claims can be reduced.

Accordingly, in one aspect, an embodiment of the present invention is directed to one or more computer storage media having computer-executable instructions embodied thereon, that when executed, perform a method of providing medical and preventive healthcare personal assistant services. The method comprises receiving healthcare data for a patient via multiple interfaces. The multiple interfaces include an electronic health record, insurance systems, pharmacy systems, remote monitoring systems, clinician scheduling systems, patient social media accounts, and a patient mobile device. The method also comprises providing the healthcare data to a machine learning device. The machine learning device is trained to analyze the healthcare data. The method further comprises, based on the analysis of the healthcare data, providing medical and preventive healthcare personal assistant services for the patient via the patient mobile device.

In another aspect of the invention, an embodiment is directed to one or more computer storage media having computer-executable instructions embodied thereon, that when executed, perform a method for providing medical and preventive healthcare personal assistant services. The method comprises receiving healthcare data for a patient via multiple interfaces. The method also comprises providing the healthcare data to a machine learning device. The machine learning device is trained to analyze the healthcare data. The method further comprises, based on the analysis of the healthcare data, providing medical and preventive healthcare personal assistant services for the patient via the patient mobile device. The medical and preventive healthcare personal assistant services comprising one or more of: recommending physical actions to be taken by the user in accordance with a specific condition, medical history, and other information derived from the healthcare data, automatically seeking or scheduling appointments with clinicians or laboratory or testing facilities, or communicating prescriptions or refill requests to pharmacies and/or orders for over-the counter medications to vendors.

In a further aspect, an embodiment is directed to a system in a healthcare computing environment that enables providing medical and preventive healthcare personal assistant services. The system comprises a processor; and a non-transitory computer storage medium storing computer-useable instructions that, when used by the processor, cause the processor to: receive healthcare data for a patient via multiple interfaces, the multiple interfaces including an electronic health record, insurance systems, pharmacy systems, remote monitoring systems, clinician scheduling systems, patient social media systems, and a patient mobile device, the healthcare data received via patient social media accounts including postings, blogs, pictures, or interactions with postings, blogs, or pictures of other users and the healthcare data received via insurance systems including insurance eligibility information that includes coverage, co-pays, or balance of deductibles; provide the healthcare data to a machine learning device, the machine learning device trained to analyze the healthcare data; based on the analysis of the healthcare data, provide medical and preventive healthcare personal assistant services for the patient via the patient mobile device.

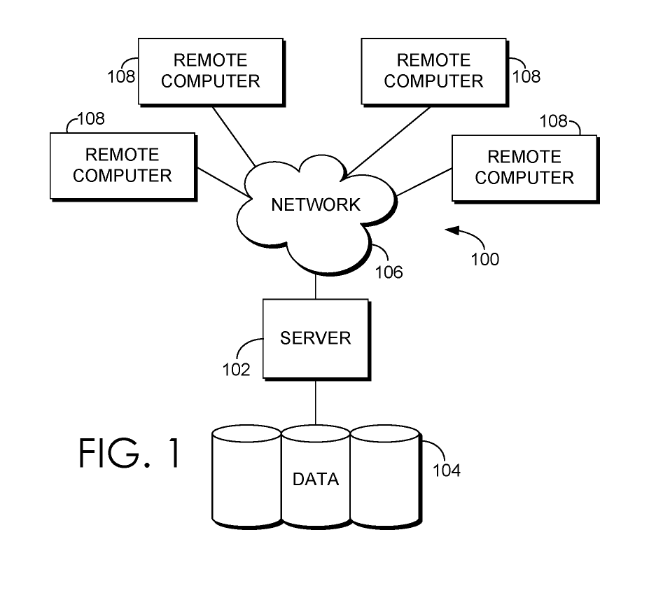

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, wearable devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, ambulatory settings, medical billing and financial offices, hospital administration settings, home healthcare environments, clinicians' offices, Center for Disease Control, Centers for Medicare & Medicaid Services, World Health Organization, any governing body either foreign or domestic, Health Information Exchange, and any healthcare/government regulatory bodies not otherwise mentioned. Clinicians may comprise a treating physician or physicians; specialists such as intensivists, surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

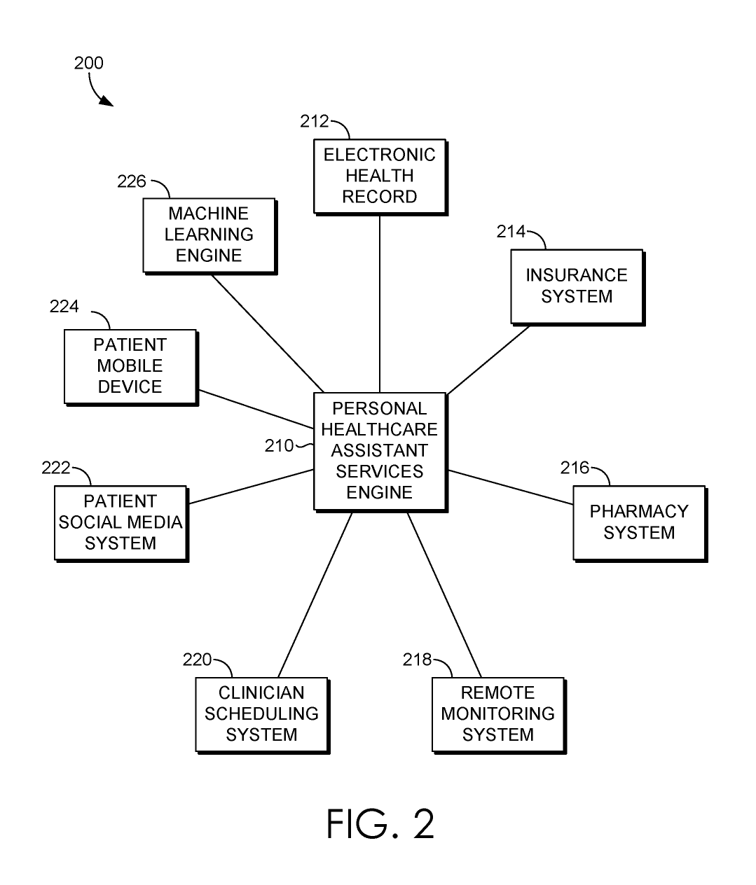

Turning now to FIG. 2, an exemplary computing system environment 200 is depicted suitable for use in implementing embodiments of the present invention. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes personal healthcare assistant services engine 210, EHR 212, insurance system 214, pharmacy system 216, remote monitoring system 218, clinician scheduling system 220, patient social media system 222, patient mobile device 224, and machine learning engine 226, all in communication with one another via a network (not shown in FIG. 2). The network may include, without limitation, one or more secure local area networks (LANs) or wide area networks (WANs). The network may be a secure network associated with a facility such as a healthcare facility. The secure network may require that a user log in and be authenticated in order to send and/or receive information over the network.

In some embodiments, one or more of the illustrated components/modules may be implemented as stand-alone applications. In other embodiments, one or more of the illustrated components/modules may be distributed across personal healthcare assistant services engines. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the personal healthcare assistant services engine 210 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The personal healthcare assistant services engine 210 is configured to receive information from each of the EHR 212, insurance system 214, pharmacy system 216, remote monitoring system 218, clinician scheduling system 220, patient social media system 222, and patient mobile device 224. Information provided by EHR 212 may include electronic clinical documents such as images, clinical notes, orders, summaries, reports, analyses, information received from medical devices (not shown in FIG. 2), or other types of electronic medical documentation relevant to a particular patient's condition and/or treatment. Electronic clinical documents contain various types of information relevant to the condition and/or treatment of a particular patient and can include information relating to, for example, patient identification information, images, alert history, culture results, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, clinician assignments, and a host of other relevant clinical information.

Insurance system 214 may provide information regarding insurance coverage, provider information (i.e., both general practitioners and specialists), potential payment estimates, co-pays, balance of deductibles, and the like. Information provided by pharmacy system 216 may include medication history, providing insight into history of treatment, symptoms and unrecommended medical treatments (ex. over prescribed antibiotics, opioid use, negative drug interaction, etc.), and the like. Remote monitoring system 218 may provide information about users being monitored remotely, which may include current and historic monitoring data. Such information may provide immediate information (e.g., trends in vital statistics). Information provided by clinician scheduling system 220 may include access to clinician contact information, access to scheduling system, availability, accepted insurance, specialty practice database (i.e., including clinician area of specialization) and the like. Patient social media system 222 may provide access to patient social media accounts, which may reveal current mental and physical states of the patient (e.g. postings, blogs, pictures, or interactions with postings, blogs, or pictures of other users).

Information provided by patient mobile device 224 may include facial recognition information that might reveal emotional states of the patient (e.g., pain, depression, deception, etc.). The patient mobile device 224 may be any type of computing device capable of communicating with the personal healthcare assistant services engine 210 to communicate with and receive medical and preventive healthcare personal assistant services. Such devices may include any type of mobile and portable devices including cellular telephones, personal digital assistants, tablet PCs, smart phones, and the like.

In some embodiments, information may be derived and provided by multiple sources. This information may include data relating to age, gender, race, socio-economic variables, which may also include financial conditions and living conditions, environment, and/or region. The information may additionally include physiological variables, such as Systolic blood pressure, Diastolic blood pressure, HDL cholesterol, LDL cholesterol, Triglycerides, Total cholesterol, or Body mass index (BMI), laboratory results, or information received from medical devices. The information may also include data derived purchase history/spending habits, hobbies, diet, exercise, or other activities regarding a person, gym membership, vacation(s) or recreational activities, financial information (such as debt, income level), employment information, job satisfaction, community/friends, religion/spirituality, contacts, other personal activity information, or nearly any other such source of information relating to behavior or lifestyle.

Machine learning engine 226 is generally configured to receive information that has been collected by personal healthcare assistant services engine 210 from EHR 212, insurance system 214, pharmacy system 216, remote monitoring system 218, clinician scheduling system 220, patient social media system 222, and patient mobile device 224. The information is analyzed by machine learning engine 226 to provide medical and preventive healthcare personal assistant services for the patient via patient mobile device 224.

The medical and preventive healthcare personal assistant services may comprise one or more of: recommending physical actions (e.g., rest or consumption of specific fluids and/or foods) to be taken by the user in accordance with a specific condition, medical history, and other information derived from the healthcare data, automatically seeking or scheduling appointments with clinicians or laboratory or testing facilities, or communicating prescriptions or refill requests to pharmacies and/or orders for over-the counter medications to vendors. In some embodiments, the medical and preventive healthcare personal assistant services are based upon a severity of a condition of the patient or a length of time the patient has experienced the condition.

In some embodiments, guidance is provided to patient contacts. For example, the guidance may include monitoring, transport, or support of the patient before or after a particular action is taken. In some embodiments, information (upon being approved by the patient) is disclosed to a clinician in order to assist with the clinician's treatment recommendation. For example, if machine learning engine 226 determines a patient may have a possible concussion based upon information derived from social media information surrounding a skateboarding accident the patient may have experienced recently, or based upon the patient's history derived from the medical record (i.e., the patient has been seen for several concussions in the past few years), the clinician may provide evaluation or testing or a concussion or treat the patient accordingly.

One or more machine learning algorithms may be used to determine the appropriate medical and preventive healthcare personal assistant services that are provided. For example, an ensemble of alternating decision trees can be used to determine the appropriate medical and preventive healthcare personal assistant services. Each decision tree is trained on a random subset of instances and features of the healthcare data. In some embodiments, the number of decision trees used is based on the type of healthcare data received or specific information pertaining to the patient.

A generic decision tree is a decision support tool which arrives at a decision after following steps or rules along a tree-like path. While most decision trees are only concerned about the final destination along the decision path, alternating decision trees take into account every decision made along the path and may assign a score for every decision encountered. Once the decision path ends, the algorithm sum all of the incurred scores to determine a final classification (i.e., the medical and preventive healthcare personal assistant services). In some embodiments, the alternating decision tree algorithm may be further customized. For example, the alternating decision tree algorithm may be modified by wrapping it in other algorithms.

A machine learning algorithm may use a generic cost matrix. The intuition behind the cost matrix is as follows. If the model predicts a member to be classified in group A, and the member really should be in group A, no penalty is assigned. However, if this same member is predicted to be in group B, C, or D, a 1-point penalty will be assigned to the model for this misclassification, regardless of which group the member was predicted to be in. Thus, all misclassifications are penalized equally. However, by adjusting the cost matrix, penalties for specific misclassifications can be assigned. For example, where someone who was truly in group D was classified in group A, the model could increase the penalty in that section of the cost matrix. A cost matrix such as this may be adjusted as needed to help fine tune the model for different iterations, and may be based on the specific patient in some embodiments.

With regards to a multi-class classifier, some machine learning algorithms, such as alternating decision trees, generally only allow for the classification into two categories (e.g. a binary classification). In cases where it is desired to classify three or more categories, a multi-class classifier is used.

In order to assist the alternating decision tree in selecting best features for predictive modeling, an ensemble method called rotation forest may be used. The rotation forest algorithm randomly splits the dataset into a specified number of subsets and uses a clustering method called Principal Component Analysis to group features deemed useful. Each tree is then gathered (i.e., “bundled into a forest”) and evaluated to determine the features to be used by the base classifier.

Various alternative classifiers may be used to provide the medical and preventive healthcare personal assistant services. Indeed, there are thousands of machine learning algorithms, which could be used in place of, or in conjunction with, the alternating decision tree algorithm. For example, one set of alternative classifiers comprise ensemble methods.

Ensemble methods use multiple, and usually random, variations of learning algorithms to strengthen classification performance. Two of the most common ensemble methods are bagging and boosting. Bagging methods, short for “bootstrap aggregating” methods, develop multiple models from random subsets of features from the data (“bootstrapping”), assigns equal weight to each feature, and selects the best-performing attributes for the base classifier using the aggregated results. Boosting, on the other hand, learns from the data by incrementally building a model, thereby attempting to correct misclassifications from previous boosting iterations.

Regression models are frequently used to evaluate the relationship between different features in supervised learning, especially when trying to predict a value rather than a classification. However, regression methods are also used with other methods to develop regression trees. Some algorithms combine both classification and regression methods; algorithms that used both methods are often referred to as CART (Classification and Regression Trees) algorithms.

Bayesian statistical methods are used when the probability of some events happening are, in part, conditional to other circumstances occurring. When the exact probability of such events is not known, maximum likelihood methods are used to estimate the probability distributions. A textbook example of Bayesian learning is using weather conditions, and whether a sprinkler system has recently gone off, to determine whether a lawn will be wet. However, whether a homeowner will turn on their sprinkler system is influenced, in part, to the weather. Bayesian learning methods, then, build predictive models based on calculated prior probability distributions.

Another type of classifiers comprise artificial neural networks. While typical machine learning algorithms have a pre-determined starting node and organized decision paths, the structure of artificial neural networks are less structured. These algorithms of interconnected nodes are inspired by the neural paths of the brain. In particular, neural network methods are very effective in solving difficult machine learning tasks. Much of the computation occurs in “hidden” layers.

By way of example and not limitation, other classifiers and methods that may be utilized include (1) decision tree classifiers, such as: C4.5—a decision tree that first selects features by evaluating how relevant each attribute is, then using these attributes in the decision path development; Decision Stump—a decision tree that classifies two categories based on a single feature (think of a single swing of an axe); by itself, the decision stump is not very useful, but becomes more so paired with ensemble methods; LADTree—a multi-class alternating decision tree using a LogitBoost ensemble method; Logistic Model Tree (LMT)—a decision tree with logistic regression functions at the leaves; Naive Bayes Tree (NBTree)—a decision tree with naive Bayes classifiers at the leaves; Random Tree—a decision tree that considers a pre-determined number of randomly chosen attributes at each node of the decision tree; Random Forest—an ensemble of Random Trees; and Reduced-Error Pruning Tree (REPTree)—a fast decision tree learning that builds trees based on information gain, then prunes the tree using reduce-error pruning methods; (2) ensemble methods such as: AdaBoostM1—an adaptive boosting method; Bagging—develops models using bootstrapped random samples, then aggregates the results and votes for the most meaningful features to use in the base classifier; LogitBoost—a boosting method that uses additive logistic regression to develop the ensemble; MultiBoostAB—an advancement of the AdaBoost method; and Stacking—a method similar to boosting for evaluating several models at the same time; (3) regression methods, such as Logistic Regression—regression method for predicting classification; (4) Bayesian networks, such as BayesNet—Bayesian classification; and NaiveBayes—Bayesian classification with strong independence assumptions; and (4) artificial neural networks such as MultiLayerPerception—a forward-based artificial neural network.

Each of personal healthcare assistant services engine 210 and machine learning engine 226 may include a processing unit, internal system memory, and a suitable system bus for coupling various system components, including one or more data stores for storing information (e.g., files and metadata associated therewith). Each of personal healthcare assistant services engine 210 and machine learning engine 226 typically includes, or has access to, a variety of computer-readable media.

The computing system environment 200 is merely exemplary. While personal healthcare assistant services engine 210 and machine learning engine 226 are illustrated as single units, it will be appreciated that the personal healthcare assistant services engine 210 and machine learning engine 226 are scalable. For example, the personal healthcare assistant services engine 210 and machine learning engine 226 may in actuality include a plurality of computing devices in communication with one another. The single unit depictions are meant for clarity, not to limit the scope of embodiments in any form. In some embodiments, personal healthcare assistant services engine 210 and/or machine learning engine resides on a single device, such as patient mobile device 224.

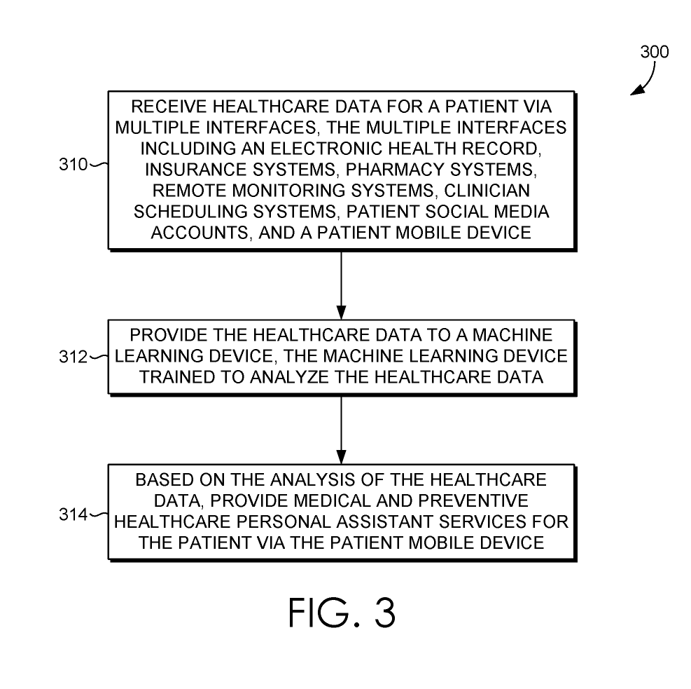

Turning now to FIG. 3, a flow diagram is provided illustrating a method 300 of identifying patients having a probable inheritance of a genetic disease, in accordance with an embodiment of the present invention. Initially, as shown at step 310, healthcare data is received for a patient via multiple interfaces, such as by using by personal healthcare assistant services 210 of FIG. 2. For example, the healthcare data may be received from an EHR, insurance systems, pharmacy systems, remote monitoring systems, clinician scheduling systems, patient social media accounts, and a patient mobile device.

In some embodiments, the healthcare data received via patient social media accounts includes postings, blogs, pictures, or interactions with postings, blogs, or pictures of other users. In some embodiments, the healthcare data received via patient social media accounts is analyzed by the machine learning device for lifestyle attributes for both physical and emotional health. In some embodiments, the healthcare data received via insurance systems includes insurance eligibility information that includes coverage, co-pays, or balance of deductibles.

At step 312, the healthcare data is provided to a machine learning device that is trained to analyze the healthcare data. Based on the analysis of the healthcare data, medical and preventive healthcare personal assistant services are provided, at step 314, for the patient via the patient mobile device.

As described above, the medical and preventive healthcare personal assistant services are generated (or updated) for the patient using machine learning algorithms. A training set of data may be used to build and/or train the medical and preventive healthcare personal assistant services, and the testing set may be used to evaluate the medical and preventive healthcare personal assistant services (and in some cases further modify, such as by adjusting weights). For example, the medical and preventive healthcare personal assistant services may recommend physical actions (e.g., rest or consumption of specific fluids and/or foods) to be taken by the user in accordance with a specific condition, medical history, and other information derived from the healthcare data. Additionally or alternatively, the medical and preventive healthcare personal assistant services may automatically seek or schedule appointments with clinicians or laboratory or testing facilities. In some embodiments, the medical and preventive healthcare personal assistant services may communicate prescriptions or refill requests to pharmacies and/or orders for over-the-counter medications to vendors. In some embodiments, the medical and preventive healthcare personal assistant services are based upon a severity of a condition of the patient or a length of time the patient has experienced the condition.

In some embodiments, guidance is provided to patient contacts. For example, the guidance may include instructions for monitoring, transport, or support of the patient before or after a particular action is taken.

The medical and preventive healthcare personal assistant services may further provide information identifying which features (or variables) of data were most significant in the recommendation (i.e., which features are more meaningful). Further, in some embodiments, these significant features may be weighted in an implemented model. As described above, machine learning algorithms might include alternating decision trees, random forest, linear logistic models, proportional hazard model, or other similar classification algorithms known to those skilled in the art. The particular model(s) and configuration used may be dependent on the data, the type of data (e.g. claims, social network, EHR, etc.), or demographic data of the patient (e.g., age, gender, race, etc.).

In some embodiments, the model may be evaluated based on outcomes. In this way, previous recommendations that were made to patients may be evaluated based on outcomes. The evaluations may be used for updating or modifying the model to be more accurate, for weighting the model, or for replacing the model with a more accurate one.

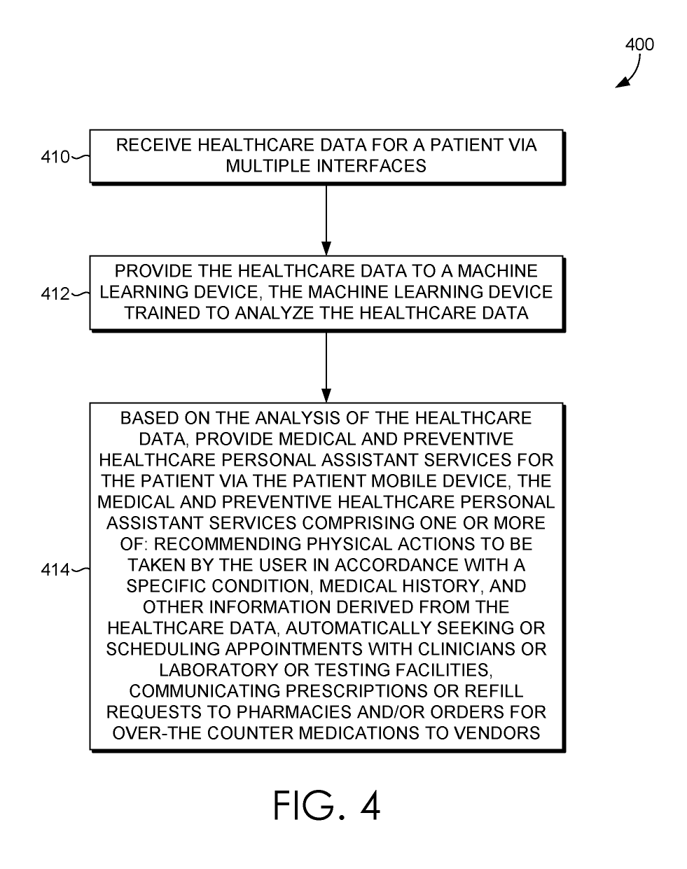

Turning now to FIG. 4, a flow diagram is provided illustrating a method 400 of medical and preventive healthcare personal assistant services, in accordance with an embodiment of the present invention. Initially, as shown at step 410, healthcare data is received for a patient via multiple interfaces, such as by using by personal healthcare assistant services 210 of FIG. 2. The multiple interfaces may include the multiple interfaces include an electronic health record, insurance systems, pharmacy systems, remote monitoring systems, clinician scheduling systems, patient social media accounts, and a patient mobile device

In some embodiments, the healthcare data is received via patient social media accounts includes postings, blogs, pictures, or interactions with postings, blogs, or pictures of other users. The healthcare data received via patient social media accounts may be analyzed by the machine learning device for lifestyle attributes for both physical and emotional health. In some embodiments, the healthcare data is received via insurance systems includes insurance eligibility information that includes coverage, co-pays, or balance of deductibles.

The healthcare data is provided to a machine learning device, at step 412. The machine learning device is trained, utilizing any of the machine learning algorithms described above, to analyze the healthcare data. Based on the analysis of the healthcare data, medical and preventive healthcare personal assistant services are provided, at step 414, for the patient via a patient mobile device.

The medical and preventive healthcare personal assistant services comprise one or more of: recommending physical actions (e.g., rest or consumption of specific fluids and/or foods) to be taken by the user in accordance with a specific condition, medical history, and other information derived from the healthcare data, automatically seeking or scheduling appointments with clinicians or laboratory or testing facilities, or communicating prescriptions or refill requests to pharmacies and/or orders for over-the counter medications to vendors. In some embodiments, the medical and preventive healthcare personal assistant services are based upon a severity of a condition of the patient or a length of time the patient has experienced the condition.

In some embodiments, guidance is provided to patient contacts. For example, the guidance may include monitoring, transport, or support of the patient before or after a particular action is taken.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described. Accordingly, the scope of the invention is intended to be limited only by the following claims.

What is claimed is:

1. One or more computer-storage media having computer-executable instructions embodied thereon that, when executed by a computing device, cause the computing device to perform a method of providing medical and preventive healthcare personal assistant services, the method comprising:
receiving healthcare data for a patient via multiple interfaces, the multiple interfaces including an electronic health record, insurance systems, pharmacy systems, remote monitoring systems, clinician scheduling systems, patient social media accounts, and a patient mobile device;
providing the healthcare data to a machine learning device, the machine learning device trained to analyze the healthcare data; and
based on the analysis of the healthcare data, providing medical and preventive healthcare personal assistant services for the patient via the patient mobile device.

2. The media of claim 1, wherein the medical and preventive healthcare personal assistant services comprise recommending physical actions to be taken by the user in accordance with a specific condition, medical history, and other information derived from the healthcare data.

3. The media of claim 1, wherein the medical and preventive healthcare personal assistant services comprise automatically seeking or scheduling appointments with clinicians or laboratory or testing facilities.

4. The media of claim 1, wherein the medical and preventive healthcare personal assistant services comprise communicating prescriptions or refill requests to pharmacies and/or orders for over-the-counter medications to vendors.

5. The media of claim 2, wherein the physical actions include rest or consumption of specific fluids and/or foods,

6. The media of claim 1, wherein the medical and preventive healthcare personal assistant services are based upon a severity of a condition of the patient or a length of time the patient has experienced the condition.

7. The media of claim 1, further comprising providing guidance to patient contacts.

8. The media of claim 7, wherein the guidance includes instructions for monitoring, transport, or support of the patient before or after a particular action is taken.

9. The media of claim 1, wherein the healthcare data received via patient social media accounts includes postings, blogs, pictures, or interactions with postings, blogs, or pictures of other users.

10. The media of claim 1, wherein the healthcare data received via insurance systems includes insurance eligibility information that includes coverage, co-pays, or balance of deductibles.

11. The media of claim 1, wherein the healthcare data received via patient social media accounts is analyzed by the machine learning device for lifestyle attributes for both physical and emotional health.

12. A method for providing medical and preventive healthcare personal assistant services, the method comprising:
receiving healthcare data for a patient via multiple interfaces;
providing the healthcare data to a machine learning device, the machine learning device trained to analyze the healthcare data;
based on the analysis of the healthcare data, providing medical and preventive healthcare personal assistant services for the patient via a patient mobile device, the medical and preventive healthcare personal assistant services comprising one or more of: recommending physical actions to be taken by the user in accordance with a specific condition, medical history, and other information derived from the healthcare data, automatically seeking or scheduling appointments with clinicians or laboratory or testing facilities, or communicating prescriptions or refill requests to pharmacies and/or orders for over-the counter medications to vendors.

13. The method of claim 12, wherein the physical actions include rest or consumption of specific fluids and/or foods.

14. The method of claim 12, wherein the medical and preventive healthcare personal assistant services are based upon a severity of a condition of the patient or a length of time the patient has experienced the condition.

15. The method of claim 12, further comprising providing guidance to patient contacts, the guidance including monitoring, transport, or support of the patient before or after a particular action is taken.

16. The method of claim 12, wherein the multiple interfaces include an electronic health record, insurance systems, pharmacy systems, remote monitoring systems, clinician scheduling systems, patient social media accounts, and a patient mobile device

17. The method of claim 16, wherein the healthcare data received via patient social media accounts includes postings, blogs, pictures, or interactions with postings, blogs, or pictures of other users

18. The method of claim 16, wherein the healthcare data received via insurance systems includes insurance eligibility information that includes coverage, co-pays, or balance of deductibles.

19. The method of claim 18, wherein the healthcare data received via patient social media accounts is analyzed by the machine learning device for lifestyle attributes for both physical and emotional health.

20. A computerized system comprising:
one or more processors; and
computer storage memory having computer-executable instructions stored thereon which, when executed by the processor, cause the one or more processors to:
receive healthcare data for a patient via multiple interfaces, the multiple interfaces including an electronic health record, insurance systems, pharmacy systems, remote monitoring systems, clinician scheduling systems, patient social media systems, and a patient mobile device, the healthcare data received via patient social media accounts including postings, blogs, pictures, or interactions with postings, blogs, or pictures of other users and the healthcare data received via insurance systems including insurance eligibility information that includes coverage, co-pays, or balance of deductibles;
provide the healthcare data to a machine learning device, the machine learning device trained to analyze the healthcare data;
based on the analysis of the healthcare data, provide medical and preventive healthcare personal assistant services for the patient via the patient mobile device.
